(19) United States
(12) Patent Application Publication
(10) Pub. No.: US 2025/0028934 A1
(43) Pub. Date: Jan. 23, 2025

(54) SYSTEMS AND METHODS FOR TIME SERIES PREDICTION USING MULTI-STAGE COMPUTATION

(71) Applicant: The Toronto-Dominion Bank, Toronto (CA)

(72) Inventors: Ling Wong, Markham (CA); Mahdi Ghelichi, Toronto (CA); Amin Haeri, Toronto (CA); Lily Jan Jaroszek, Toronto (CA)

(21) Appl. No.: 18/353,658

(22) Filed: Jul. 17, 2023

(51) Int. Cl. G06N 3/0455; G06N 3/0442; G06N 20/20

(52) U.S. Cl. CPC G06N 3/0455; G06N 3/0442; G06N 20/20

(57) ABSTRACT

Systems and methods for computing time series predictions are provided, including a two-stage classifier-and-regressor processor. The classifier is trained on the complete data set while the regressor is trained on a pruned dataset. The classifier includes an Extreme Gradient Boosting classifier. The regressor includes an attention mechanism and a Long Short-Term Memory (LSTM) neural network. For a series of successive time period computations, a current output of the LSTM neural network is recursively fed back as an input to the attention mechanism for a subsequent time period computation. The output of the regressor is scaled by the output of the classifier to adjust for overfitting caused by the pruned training dataset.

### TECHNICAL FIELD

The disclosed exemplary embodiments relate to computer-implemented systems and methods for computing time series predictions and, in particular, to systems and methods that include a combined classifier-regressor prediction processor.

### BACKGROUND

Data processing large data sets can be challenging, particularly when attempting to predict characteristics about a specific set of data entries that is part of a large data set. The problem is even more challenging when the specific set of data entries is not easily identifiable from the large data set, and the specific set of data entries are a relatively small portion of the large data set.

A conventional approach to predicting characteristics about a specific set of data includes using a conventional processor (for example, a central processing unit) to apply data filters based on trackable parameters within the large data set. This type of approach is computationally slow and prone to inaccurate predictions.

Nevertheless, in at least some examples, it may be desirable to predict characteristics of assets (e.g., machinery, goods, infrastructure, property, debt, etc.) so that an action can be taken based on the predicted characteristics of the assets.

### SUMMARY

The following summary is intended to introduce the reader to various aspects of the detailed description, but not to define or delimit any invention.

In at least one broad aspect, there is provided an apparatus for generating time series predictions from a first dataset comprising a first plurality of data entries and having a first feature space. The apparatus includes: a memory storing instructions; and one or more processors coupled to the memory. The one or more processors are configured to execute the instructions to:
encode the first dataset to generate a latent vector having a latent space smaller than the first feature space;
for a first time period (n=1) in a plurality of time periods:
   process the latent vector using an attention mechanism to generate a first attention vector;
   process the first attention vector using an LSTM (Long Short-Term Memory) neural network model to generate a first latent prediction vector;
   decode the first latent prediction vector to generate a first prediction vector of a plurality of time series prediction vectors having a second feature space larger than the latent space;
for each successive n^{th} time period (n>1) in the plurality of time periods:
   process the latent vector and an (n−1)^{th} latent prediction vector using the attention mechanism to generate an n^{th} attention vector;
   process the n^{th} attention vector using the LSTM (Long Short-Term Memory) neural network model to generate an n^{th} latent prediction vector;
   decode the n^{th} latent prediction vector to generate an n^{th} prediction vector of the plurality of time series prediction vectors in the second feature space;
classify the first dataset using an XGBoost (Extreme Gradient Boosting) classifier to generate a classified dataset, the classified dataset comprising a set of probability weights from 0 to 1; and
scale each of the plurality of time series prediction vectors based on the classified dataset to generate a weighted plurality of time series prediction vectors, each of the weighted plurality of time series prediction vectors having a plurality of prediction values corresponding to the first plurality of data entries.

In some cases, the instructions further cause the one or more processors to segment the weighted plurality of time series prediction vectors according to the plurality of prediction values.

In some cases, the instructions further cause the one or more processors to provide for displaying a subset of the weighted plurality of time series prediction vectors.

In some cases, the encoder, the attention mechanism, the LSTM neural network model, and the decoder form a regressor mechanism. In some cases, the regressor mechanism is trained using a first training dataset and the XGBoost classifier is trained using a second training dataset, and wherein the first training dataset is a subset of the second training dataset.

In some cases, the first training dataset is generated by trimming the second training dataset to remove entries associated with overrepresented values.

In some cases, the overrepresented values are zeroes.

In some cases, the one or more processors comprises a central processing unit (CPU) and a graphical processing unit (GPU).

In some cases, the first plurality of data entries comprises a plurality of user accounts and data associated with each one of the plurality of user accounts.

In some cases, each one of the weighted plurality of time series prediction vectors comprises a prediction value corresponding to a given user account of the plurality of user accounts, each one of the plurality of time periods is one month, and the one or more processors are configured to executed the instructions to further compile a specific set of prediction values from across the weighted plurality of time series prediction vectors that is specific to the given user account into at least a time graph or a time chart.

In some cases, the data associated with each one of the plurality of user accounts comprises credit data, and the plurality of prediction values comprises a plurality of debt recovery rates corresponding to the plurality of time periods for the given user account.

In another broad aspect, there is provided a method for generating time series predictions from a first dataset comprising a first plurality of data entries and having a first feature space. The method is executed in a computing environment comprising one or more processors and memory. The method comprises:
encoding the first dataset to generate a latent vector having a latent space smaller than the first feature space;
for a first time period (n=1) in a plurality of time periods:
   processing the latent vector using an attention mechanism to generate a first attention vector;
   processing the first attention vector using an LSTM neural network model to generate a first latent prediction vector;
   decoding the first latent prediction vector to generate a first prediction vector of a plurality of time series prediction vectors having a second feature space larger than the latent space;
for each successive n^{th} time period (n>1) in the plurality of time periods:
   processing the latent vector and an (n−1)^{th} latent prediction vector using the attention mechanism to generate an n^{th} attention vector;
   processing the nth attention vector using the LSTM neural network model to generate an nth latent prediction vector;
   decoding the nth latent prediction vector to generate an n^{th} prediction vector of the plurality of time series prediction vectors in the second feature space;
classifying the first dataset using an XGBoost classifier to generate a classified dataset, the classified dataset comprising a set of probability weights from 0 to 1; and
scaling each of the plurality of time series prediction vectors based on the classified dataset to generate a weighted plurality of time series prediction vectors, each of the weighted plurality of time series prediction vectors having a plurality of prediction values corresponding to the first plurality of data entries.

In some cases, the method further comprises segmenting the weighted plurality of time series prediction vectors according to the plurality of prediction values.

In some cases, the method further comprises providing for display a subset of the weighted plurality of time series prediction vectors.

In some cases, the encoder, the attention mechanism, the LSTM neural network model, and the decoder form a regressor mechanism. In some cases, the regressor mechanism is trained using a first training dataset and the XGBoost classifier is trained using a second training dataset, and wherein the first training dataset is a subset of the second training dataset.

In some cases, the first training dataset is generated by trimming the second training dataset to remove entries associated with overrepresented values.

In some cases, the overrepresented values are zeroes.

In some cases, the one or more processors comprises a CPU and a GPU.

In some cases, the first plurality of data entries comprises a plurality of user accounts and data associated with each one of the plurality of user accounts.

In some cases, each one of the weighted plurality of time series prediction vectors comprises a prediction value corresponding to a given user account of the plurality of user accounts, each one of the plurality of time periods is one month, and the method further comprises compiling a specific set of prediction values from across the weighted plurality of time series prediction vectors that is specific to the given user account into at least a time graph or a time chart.

A system and a method are provided for computing time series predictions, including a two-stage classifier-and-regressor processor. A classifier is trained on the complete data set while the regressor is trained on a pruned dataset. The classifier includes an Extreme Gradient Boosting classifier. A regressor includes an attention mechanism and a Long Short-Term Memory (LSTM) neural network. For a series of successive time period computations, a current output of the LSTM neural network is recursively fed back as an input to the attention mechanism for a subsequent time period computation. The output of the regressor is scaled by the output of the classifier to adjust for overfitting caused by the pruned training dataset.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1A is a schematic block diagram of a system for computing time series predictions in accordance with at least some embodiments;

FIG. 1B is a schematic block diagram of an enterprise data provisioning platform of FIG. 1A in accordance with at least some embodiments;

FIG. 2 is a block diagram of a computer in accordance with at least some embodiments;

FIG. 3 is a schematic block diagram of a prediction processor in accordance with at least some embodiments;

FIGS. 4A and 4B is a flowchart diagram of an example method of preprocessing data and executing a two-stage classifier-and-regressor machine learning model for computing time series predictions in accordance with at least some embodiments;

FIG. 5 is a block diagram showing example components of a first dataset that includes a first plurality of data entries in accordance with at least some embodiments;

FIG. 6 is a block diagram showing example components of a classified dataset in accordance with at least some embodiments;

FIG. 7 is a block diagram showing example components of a weighted plurality of time series prediction vectors that includes a plurality of prediction values corresponding to the first plurality of data entries in the first dataset, in accordance with at least some embodiments;

FIG. 8 is a block diagram showing an example of post processed data that includes segments of data based on predicted values in accordance with at least some embodiments;

FIG. 9 is a block diagram showing an example of post processed data that includes a graph of predicted values compared against time periods, in accordance with at least some embodiments;

FIG. 10 is a schematic block diagram of a system for computing time series predictions in accordance with at least some embodiments;

FIG. 11 is a schematic block diagram of an attention mechanism in accordance with at least some embodiments;

FIG. 12 is a schematic block diagram of a Long-Short Term Memory (LSTM) Neural Network (NN) model in accordance with at least some embodiments; and

FIG. 13 is a flowchart diagram of an example method of training the prediction processor, which includes a classifier and a regressor, in accordance with at least some embodiments.

### DETAILED DESCRIPTION

Among different machine learning algorithms, tree-based algorithms are one of the most widely-used supervised learning methods. Tree-based methods (Decision trees) offer high predictive power, stability, and ease of interpretation. Unlike linear models, they map non-linear relationships relatively well. They can be utilized for solving both regression and classification tasks with minimal data cleaning or feature scaling. However, decision trees are prone to overfitting. To alleviate this problem, ensemble approaches may be used. Ensemble methods combine several decision trees to produce better predictive performance than a single decision tree. Bagging and boosting are two of the main ensemble methods. Bagging averages the predictions from all individual trees. In boosting, trees are learned sequentially with each tree focusing on the misclassified samples (errors) of the succeeding trees. Gradient boosting uses a gradient descent algorithm to minimize the error when adding new trees. Gradient boosting methods are shown to surpass the bagging approaches in terms of performance and accuracy. Boosting focuses step by step on difficult samples which are mostly the minority examples in imbalanced datasets.

Extreme Gradient Boosting (XGBoost) is an advanced implementation of Gradient Boosting. This algorithm has high predictive power and is much faster than any other gradient boosting techniques. Moreover, it includes a variety of regularization which reduces overfitting and improves overall performance. In some of the described embodiments, XGBoost is used as the first stage of the model, i.e., the classifier.

For time series problems, however, XGBoost is not an ideal solution. Rather, recurrent neural networks (RNN), as a deep learning architecture, are specifically designed for temporal problems. Accordingly, RNNs generally are the preferred algorithm for sequential data such as time series, speech, text, audio, video, financial data, and weather. The use cases include, but are not limited to, natural language processing (NLP), stock prediction, and image captioning. They are distinguished by their “memory” mechanism as they take information from prior inputs and/or outputs to influence the current output. In other words, the output of RNNs depends on the prior elements within the sequence. The other advantage of them is that the input and output lengths can be variable in this architecture, which are called input/output sequences (as opposed to vectors).

In short, an XGBoost-style classifier may be unsuited to producing time series predictions. Conversely, regressors handle time series predictions well but are prone to overfitting when trained on a complete dataset that is heavily zero-weighted.

The embodiments described herein generally provide for a combined classifier and regressor prediction processor for computing time series predictions.

In some of the described embodiments, a two-stage classifier-and-regressor model is provided. The classifier is trained on a complete data set while the regressor is trained on a pruned dataset in which zeroes have been removed. The output of the regressor is scaled by the output of the classifier to adjust for overfitting caused by the pruned training dataset. The resulting architecture can be used to predict characteristics for large data sets over a time series.

In at least one embodiment, an XGBoost classifier is paired with a regressor. In particular, the regressor is a LSTM regressor and it includes a LSTM neural network model, which is a modified version of an RNN. The regressor may also include an attention block. The regressor may also include an encoder and a decoder to reduce the feature space.

Further processing of the output predictions can be performed, including grouping the data entries into segments of predicted values (e.g., 1% likelihood, 2% likelihood, 3% likelihood, and so forth).

Supervised learning models are usually divided into ‘Regression’ and ‘Classification’ tasks. Regression algorithms attempt to estimate the mapping function from the input variables to continuous numerical output variables, while classification algorithms try to estimate the mapping function for discrete numerical output variables.

In some cases of the embodiments described herein, a two-stage model includes an XGBoost classifier and a regressor that includes an attention mechanism and an LSTM neural network. For a series of successive time period computations, a current output of the LSTM neural network is recursively fed back as an input to the attention mechanism for a subsequent time period computation. The output of the regressor is scaled by the output of the classifier to adjust for overfitting caused by a pruned training dataset.

In some cases, the embodiments described herein are used to compute time series of predictions of features or characteristics related to assets (e.g., machinery, goods, infrastructure, property, debt, etc.) so that an action can be taken based on the predicted features or characteristics of the assets. For example, a time series of predicted likelihoods of features of an asset, which vary by future time periods, can be used to determine whether or not to execute an action with respect to the asset. This information can also be used to determine one or more time periods in the future when or when not to execute the action with respect to the asset.

In an example case of a relationship between a customer and an institution in which the customer has debt owed to the institution, the embodiments described herein are used to compute a time series of predicted likelihoods of recovering a debt asset. For example, a time series of predicted likelihoods of recovering debt assets, which may vary by future time period, could be used by the institution to determine whether or not to transfer the debt to a third party. This information could also be used to determine one or more time periods when to transfer the debt or when not to transfer the debt to a third party.

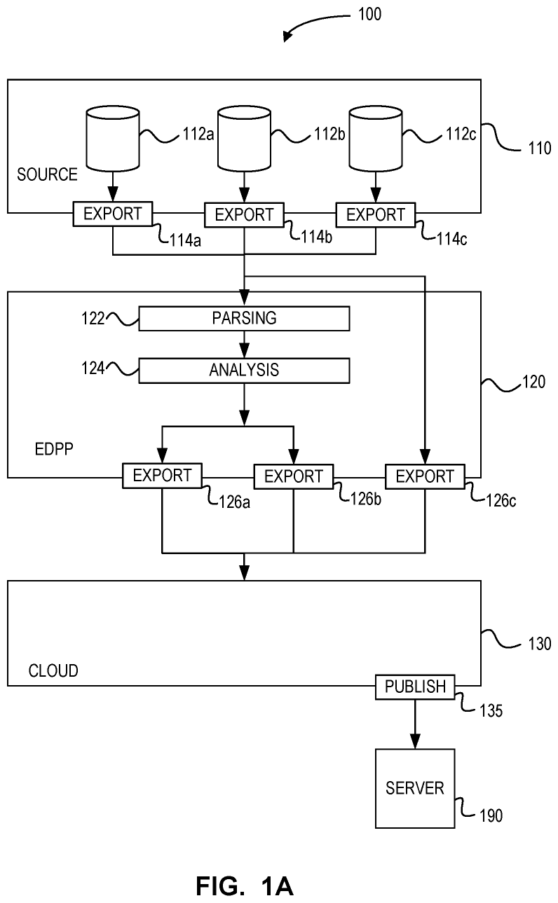

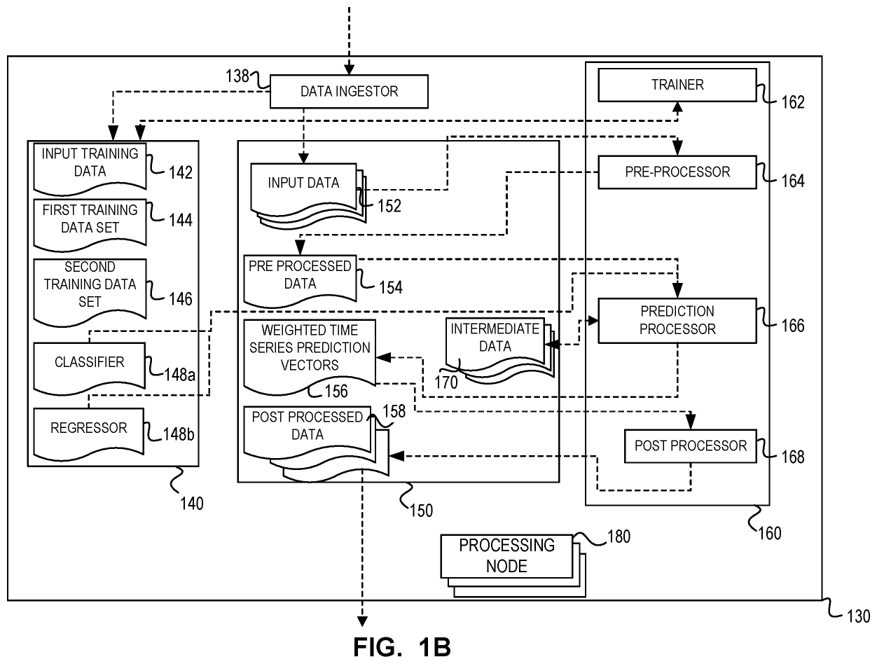

Referring now to FIG. 1A, there is illustrated a block diagram of an example computing system, in accordance with at least some embodiments. Computing system 100 has a source database system 110, an enterprise data provisioning platform (EDPP) 120 operatively coupled to the source database system 110, and a cloud-based computing cluster 130 that is operatively coupled to the EDPP 120. In some cases. this computing system 100 is provided for automated data processing of large data sets, including computing a time series of predicted characteristics of assets identified within the large data sets.

Source database system 110 has one or more databases, of which three are shown for illustrative purposes: database 112a, database 112b and database 112c. One or more the databases of the source database system 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis. In some cases, the export data may be exported in the form of comma separated value (CSV) data, however other formats may also be used.

EDPP 120 receives source data exported by the export modules 114 of source database system 110, processes it and exports the processed data to an application database within the cluster 130. For example, a parsing module 122 of EDPP 120 may perform extract, transform and load (ETL) operations on the received source data.

In many environments, access to the EDPP may be restricted to relatively few users, such as administrative users. However, with appropriate access permissions, data relevant to an application or group of applications (e.g., a client application) may be exported via reporting and analysis module 124 or an export module 126. In particular, parsed data can then be processed and transmitted to the cloud-based computing cluster 130 by a reporting and analysis module 124. Alternatively, one or more export modules 126 can export the parsed data to the cluster 130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of PII in the confidential data. Moreover, such “on-premises” systems typically are designed with access controls to limit access to the data, and thus may not be resourced or otherwise suitable for use in broader dissemination of the data. To comply with such restrictions, one or more module of EDPP 120 may “de-risk” data tables that contain confidential data prior to transmission to cluster 130. This de-risking process may, for example, obfuscate or mask elements of confidential data, or may exclude certain elements, depending on the specific restrictions applicable to the confidential data. The specific type of obfuscation, masking or other processing is referred to as a “data treatment.”

Referring now to FIG. 1B, there is illustrated a block diagram of computing cluster 130, showing greater detail of the elements of the cluster, which may be implemented by computing nodes of the cluster that are operatively coupled.

The components of the computing cluster 130 include a data ingestor 138 and a prediction system 160. The prediction system 160 includes a trainer 162, a pre-processor 164, a prediction processor 166, and a post processor 168. These modules in the prediction system 160 are implemented as one or more processing nodes 180 in the computing cluster. Similarly, the data ingestor 138 is implemented as one or more processing nodes 180 in the computing cluster. In some cases, the modules of the trainer 162, the pre-processor 164, the prediction processor 166 and the post processor 168 are each implemented as a virtual machine within the computing cluster 130.

The computing cluster 130 also includes a file system or data store 140 for storing training data and another file system or data store 140 for executing the time series prediction computations. In some cases, the file systems 140 and 150 are combined into a single file system. In some cases, the file systems 140, 150 are a distributed file system such as the Hadoop Distributed File System (HDFS). HDFS can be used to implement one or more application database 139, each of which may contain one or more tables, and which may be partitioned temporally or otherwise.

Within cluster 130, both data received from reporting and analysis module 124 and data received from export modules 126 is ingested by a data ingestion module 138. Ingested data may be stored in the file systems 140, 150.

In a training phase, the data ingestor 138 ingests data and stores input training data 142. The trainer 162 preprocesses the input training data 142 and produces a first training data set 144 and a second training data set 146. In some cases, the first training data set is a subset of the second training data set. For example, the trainer 162 trims the second training dataset to remove entries associated with overrepresented values to generate the first training dataset. In some cases, a zero value is considered an outlier that skews the prediction. Accordingly, the overrepresented values are zeroes and associated entries are removed to produce the first training dataset.

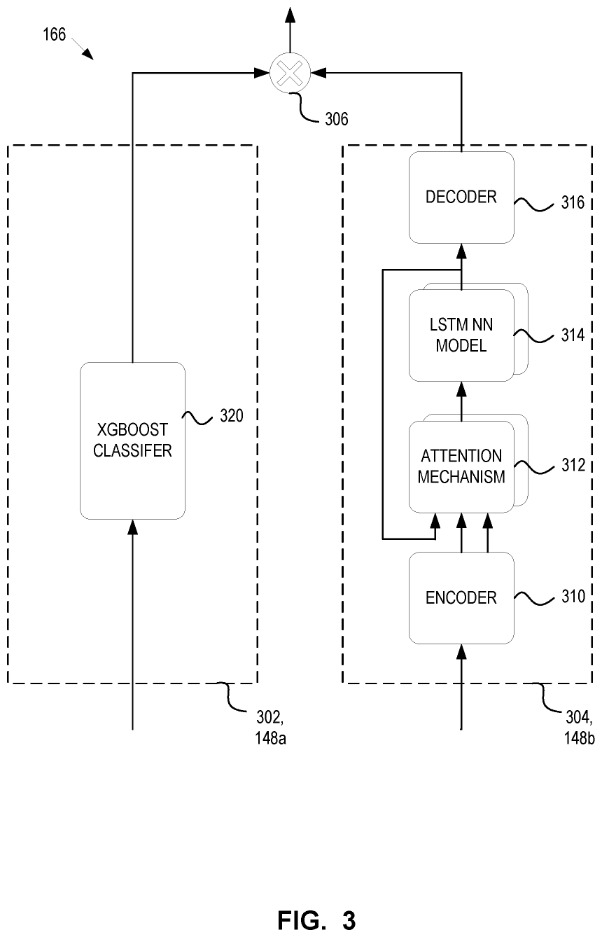

The trainer 162 uses the first training data set 144 to train a regressor mechanism 148b, and the trainer 162 uses the second training set 146 to train a classifier mechanism 148a. In some cases, the classifier mechanism is XGBoost classifier, and the regressor mechanism includes an encoder, an attention mechanism, an LSTM neural network model, and a decoder. These components are stored in the prediction processor 166, which is described in more detail in FIG. 3.

Continuing with FIG. 1B, after the classifier mechanism 148a and the regressor mechanism 148b have been trained and updated in the prediction processor 166, the time series prediction computations may be implemented using the computing cluster 130.

In the time series prediction computations phase, the data ingestor 138 receives and ingests data, which is stored as input data 152. In an example aspect, the input data 152 is processed by pre-processor 164 to generate pre-processed data 154. The pre-processed data 154 is then inputted into the prediction processor 166, which generates intermediate data 170 and outputs a weighted plurality of time series prediction vectors 156. These vectors 156 are then inputted into a post processor 168, which processes the same and outputs post-processed data 158. The post process data 158 is published 135 to a server 190 or other computer nodes, or both.

It will be appreciated that, while the components shown in FIG. 1B for the computing cluster 300 can be implemented in the system in FIG. 1A, in some other cases, the components shown in FIG. 1B are instead implemented in an isolated computing server system. In other words, the components shown in FIG. 1B can be implemented as a processing node 180.

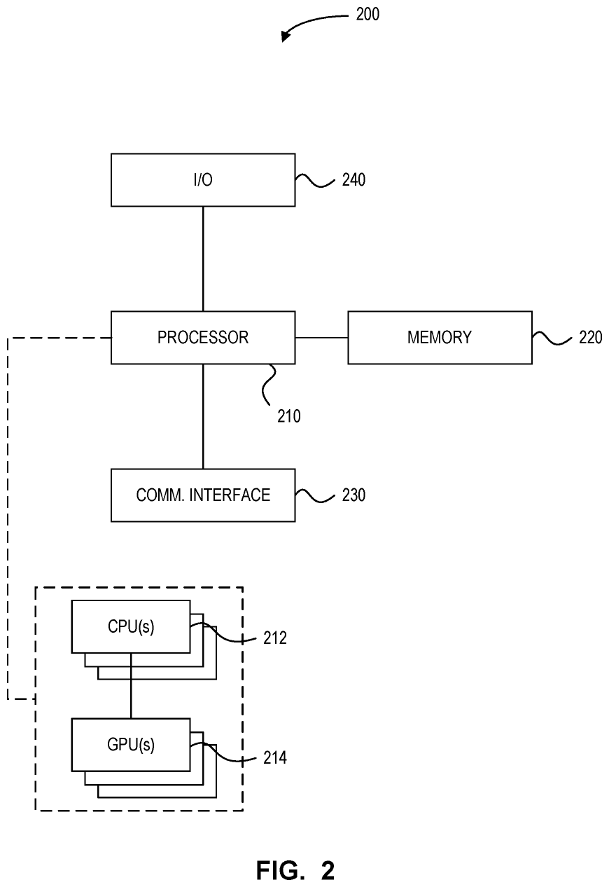

Referring now to FIG. 2, there is illustrated a simplified block diagram of a computer in accordance with at least some embodiments. Computer 200 is an example implementation of a computer such as source database system 110, EDPP 120, processing node 180 of FIG. 1. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data—e.g., within a database—along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together. For example, the prediction processor 166 executes machine learning computations on CPU and GPU hardware, such as the system of CPUs 212 and GPUs 214.

Referring now to FIG. 3, an example embodiment is provided showing components of a prediction processor 166. The components include a classifier mechanism 302 (which may be a trained classifier mechanism 148a) and a regressor mechanism 304 (which may be a trained regressor mechanism 148b). This implementation is a two-stage classifier-and-regressor model.

Pre-processed data 154 is inputted into both the classifier mechanism 302 and the regressor mechanism 304. The classifier mechanism outputs a set of weights. The regressor mechanism outputs a plurality of time series prediction vectors. A scaler 306 modifies the plurality of time prediction vectors against the set of weights, for example, using scaling function, to compute and output a plurality of weighted time series prediction vectors 156.

The classifier mechanism 302 includes an XGBoost classifier 320. The regressor mechanism 304 includes an encoder 310, an attention mechanism 312, an LSTM neural network model 314, and a decoder 316 The classifier mechanism 302, and particularly the XGBoost classifier 320, reduces the impact of imbalances in the data. The encoder 310 works with lower dimensional data. The attention mechanism 302 attends to certain feature embeddings. The LSTM neural network model 314 predicts an output sequence while considering previous predictions. The decoder 316 computes an output with a desired dimension.

In the regressor mechanism 304, for a given time period (e.g., TP=n) the output of the encoder 310 is inputted into the attention mechanism 312. The output for the LSTM neural network module 314 from a previous computation corresponding to a previous time period (e.g., TP=n−1) is also inputted (e.g., as feedback) into the attention mechanism 312. The output of the attention mechanism 312 is inputted into the LSTM neural network model 314. The output of the LSTM neural network model 314 is inputted into the decoder 316. The output of the decoder 316 is scaled with the set of weights outputted by the XGBoost classifier 320. It will also be appreciated that the output of the LSTM neural network model 314 is also inputted into the attention mechanism 312 for a computation for a subsequent future time period (e.g., TP=n+1).

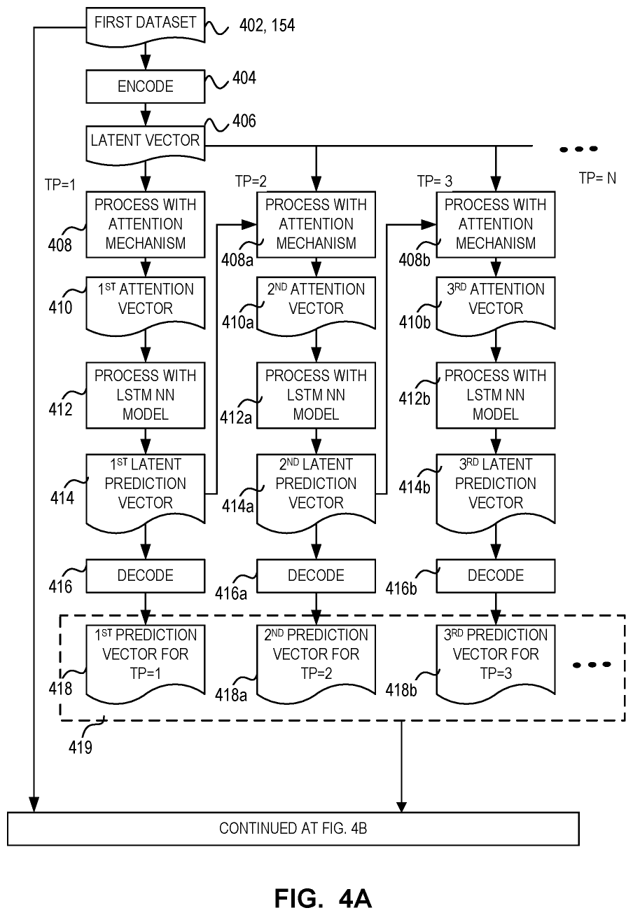

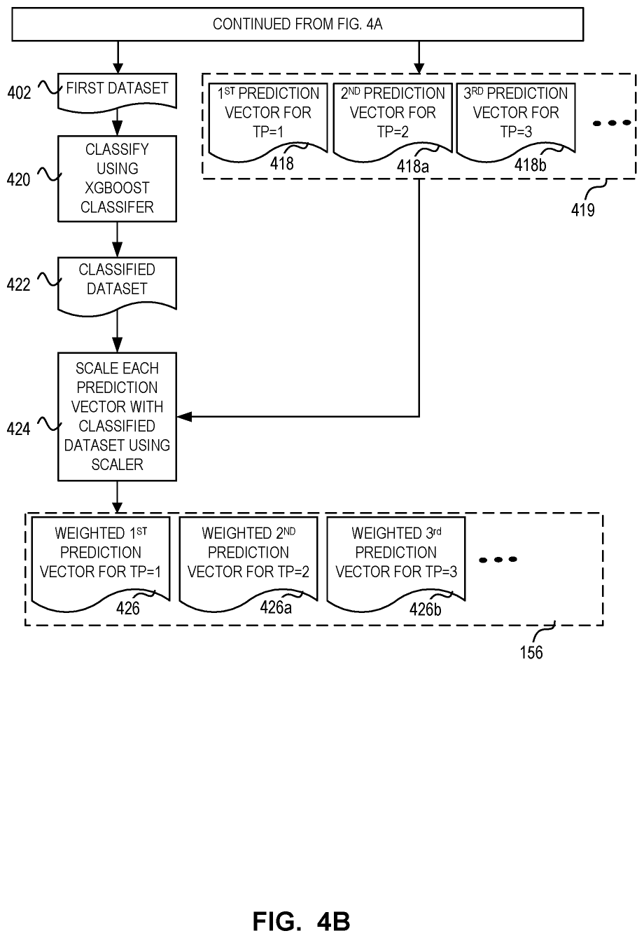

Referring to FIGS. 4A and 4B, an example embodiment of a computation process using the prediction processor 166 is provided.

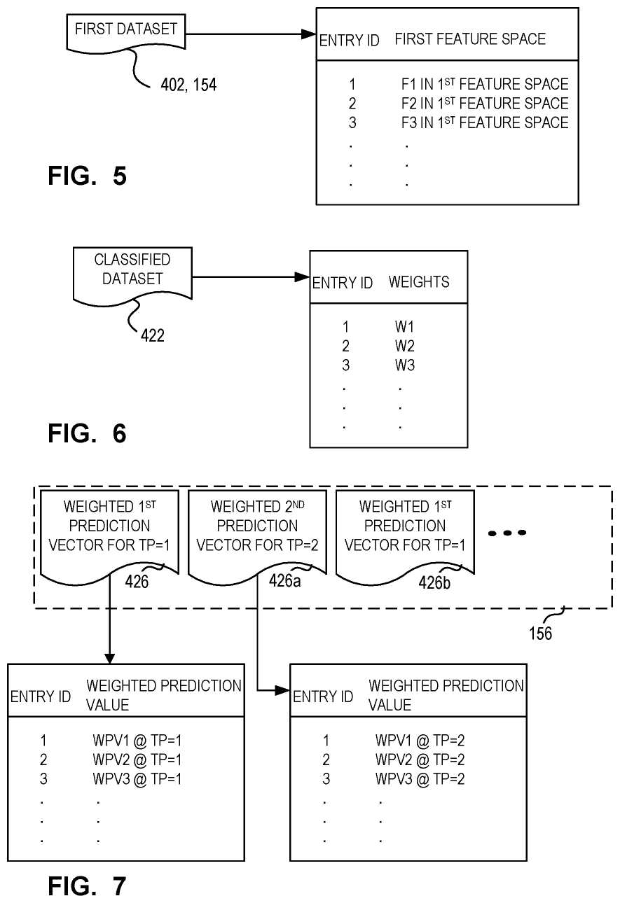

A first dataset 402 is encoded 404 using the encoder 310. The first data set includes a first plurality of data entries and has a first feature space, which may be relatively large. For example, turning briefly to FIG. 5, the first data set includes a first plurality of data entries that are each identifiable with an entry ID, and each entry ID corresponding to a set of features in the first feature space. For example, entry ID 1 is associated with a set of features F1 in the first feature space; entry ID 2 is associated with a set of features F2 in the first feature space; and so forth.

Referring back to FIG. 4A, encoding the first data set 402 generates a latent vector 406. In some cases, the latent vector has a latent space smaller than the first feature space.

It will be appreciated that a plurality of prediction vectors is computed corresponding to a plurality of time periods in a time series. For a first time period (e.g., TP=1) in a plurality of time periods, the prediction processor processes 408 the latent vector 406 using the attention mechanism 312 to generate a first attention vector 410. The prediction processor then processes 412 the first attention vector 410 using the LSTM neural network model 314 to generate a first latent prediction vector 414. The prediction processor decodes 416, using the decoder 316, the first latent prediction vector 414 to generate a first prediction vector 418 for the first time period. The first prediction vector 418 is part of a plurality of time series prediction vectors 419.

The first prediction vector 418 and the other prediction vectors in the plurality of time series prediction vectors 419 have a second feature space that is larger than the latent space of the latent vector 406.

It will be appreciated that operations and data 408, 410, 412, 414, 416, 418 correspond with a first time period (e.g., TP=1).

For a subsequent time period TP=2, the prediction processor processes 408a the latent vector 406 and the first latent prediction vector 414 (e.g., associated with the previous time period) using the attention mechanism 312 to generate a second attention vector 410a. The prediction processor then processes 412a the second attention vector 410a using the LSTMN neural network model 314 to generate a second latent prediction vector 414a. The prediction processor decodes 416a, using the decoder 316, the second latent prediction vector 414a to generate a second prediction vector 418a for the second time period. The second prediction vector 418a is part of the plurality of time series prediction vectors 419.

For a third time period TP=3, a similar set of operations and data 408b, 410b, 412b, 414b, 416b, 418b are performed and generated by the prediction processor. In particular, this generates a third prediction vector for the third time period 418b.

The process continues onwards for a number of time periods. In one example instance, the time periods are months, the desired time series includes 60 months, and, therefore, there are sixty (60) time periods resulting in sixty time series prediction vectors. Other units of time periods can be used, including, e.g., a second, an hour, a day, a week, a month, a quarter, a year, and multiples thereof. The unit of the time period may vary to suit the application.

Generally, for each successive nth time period (n>1) in the plurality of time periods, the prediction processor process the latent vector and an (n−1)th latent prediction vector using the attention mechanism to generate an nth attention vector. The prediction processor then processes the nth attention vector using the LSTM neural network model to generate an nth latent prediction vector. The prediction processor then decodes the nth latent prediction vector to generate an nth prediction vector of the plurality of time series prediction vectors in the second feature space.

The process continues to FIG. 4B. The first dataset 402 is classified 420 using the XGBoost classifier 320 to generate a classified data set 422. In some cases, the classified dataset 422 includes a set of probability weights from 0 to 1.

Referring briefly to FIG. 6, an example embodiment of a classified dataset is shown that includes a listing of weights corresponding to the entry IDs in the first dataset. For example, entry ID 1 is associated with the weight W1; entry ID 2 is associated with the weight W2; and so forth.

Continuing with FIG. 4B, the prediction processor scales 424 each of the plurality of time prediction vectors 419 based on the classified dataset 422 to generate a weighted plurality of time series prediction vectors 156. For example, the first prediction vector 418 scaled based on the classified data set 422 generates a weighted first prediction vector 426; the second prediction vector 418a scaled based on the classified dataset 422 generates a weighted second prediction vector; and so forth according to the number of time periods in the time series. In other words, the weighted predictions vectors 426, 426a, 426b, etc. for each time period form the weighted plurality of time series prediction vectors 156.

In some cases, each of the weights of the weighted plurality of time series prediction vectors have a plurality of prediction values corresponding to the first plurality of data entries.

Referring to FIG. 7, an example embodiment shows that for the weighted first prediction vector 426, a listing includes multiple entry IDs that associated with multiple weighted prediction values. For example, for the weighted first prediction vector 426 associated with the first time period, entry ID 1 is associated with weighted prediction value WPV1 specific to TP=1; entry ID 2 is associated with weighted prediction value WPV2 specific to TP=1; and so forth. For the second time period, the weight second prediction vector 426a includes: entry ID 1 that is associated with weighted prediction value WPV1 specific to TP=2; entry ID 2 that is associated with weighted prediction value WPV2 specific to TP=2; and so forth.

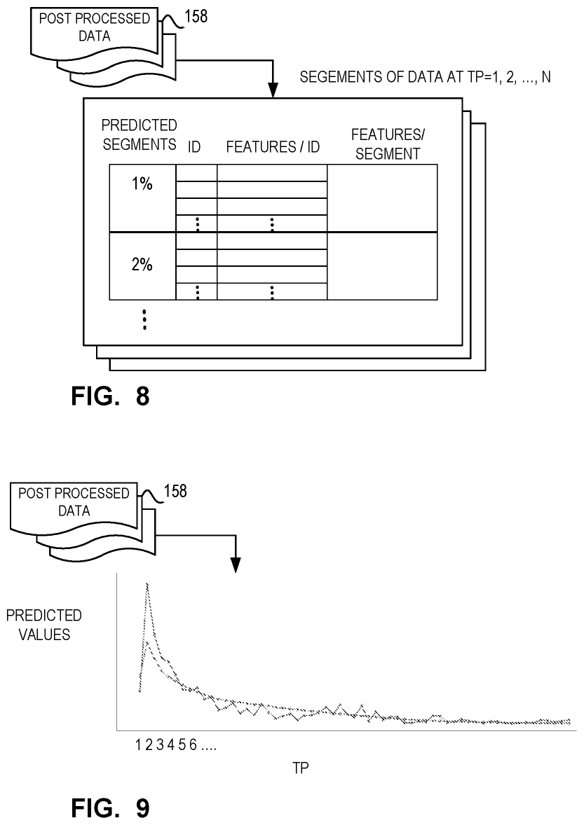

In some cases, the weighted plurality of time series prediction vectors 156 are further processed using the post processor 168 to generate post-processed data 158. Referring to FIG. 8, in some cases the post processed data 158 includes segments of data that have been segmented according to the predicted values. In other words, the post processor 168 segments the weighted plurality of time series prediction vectors according to the plurality of prediction values. In the example of FIG. 8, there is prediction value of 1% and a segment of ID entries and their features are associated with the computed prediction value of 1% (also herein called the 1% segment). In some cases, a report or a data output shows the summarized features of the ID entries that are specific to the 1% segment. In some cases, the summarized features include one or more of: a total value of certain parameters, an average value of a certain parameter, a median value of a certain parameter, a maximum value of a certain parameter, and a minimum value of a certain parameter. There may be different parameters that are characterized differently. Similarly, there is a prediction value of 2% and a segment of ID entries and their features are associated with the computed prediction value of 2% (also herein called the 2% segment). In some cases, a report or a data output shows the summarized features of the ID entries that are specific to the 2% segment. It will be appreciated that the segment of single percent units (e.g., 1% segment, 2% segment, 3% segment, etc.) are an example, and other values of unit can be used to create segments. As another example, a first segment includes prediction values in the first 10% range; a second segment includes prediction values in the second consecutive 10% range; and so forth.

Referring to FIG. 9, in some cases the post processed data 158 includes a time graph or a time chart of predicted values across a time series (e.g., multiple time periods) that is associated with a given entry ID. The time graph in FIG. 9 is a non-limiting example. In other words, the post processed data in FIG. 9 compiles prediction values across weighted plurality of time series prediction vectors 156, but has been filtered to a given entry ID.

In some cases, the data entries, or entry IDs are associated with user accounts. For example, each entry ID represents a user account and the features in the first feature space are data values associated with each user account. In a further example aspect, each one of the weighted plurality of time series prediction vectors comprises a prediction value corresponding to a given user account of the plurality of user accounts, each one of the plurality of time periods is one month, and the one or more processors are configured to executed the instructions to further compile a specific set of prediction values from across the weighted plurality of time series prediction vectors that is specific to the given user account into at least a time graph or a time chart. For example, the time graph in FIG. 9, in one example instance, shows predicted values for a given user varying across a series of months.

In some cases, the data associated with each one of the plurality of user accounts comprises credit data, and the plurality of prediction values comprises a plurality of debt recovery rates corresponding to the plurality of time periods for the given user account.

It will be appreciated that the post processed data 158 may be in various forms and provide different metrics, depending on the application.

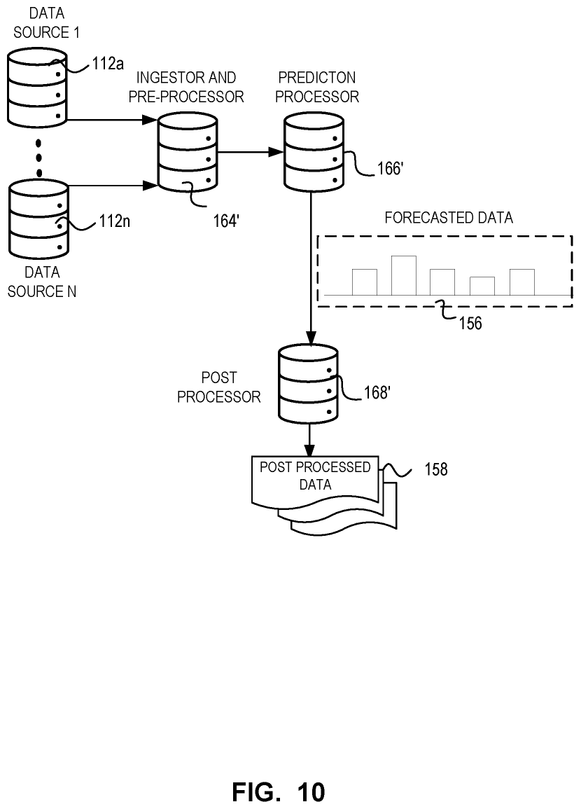

Referring to FIG. 10, another example computing system is shown. Data sources 112a and 112n provide data to an ingestor and pre-processor 164′. An ingestor and pre-processor 164′ is a server or virtual machine that include the functionality as the ingestor 138 and the pre-processor 164. Another server or virtual machine 166′ is dedicated to executing the operations of the prediction processor 166. The server or virtual machine 166′ outputs the data predictions, in the form of the weighted plurality of time series prediction vectors 156. The weighted plurality of time series prediction vectors 156 are further processed by another server or virtual machine 168′ that executes the operations of the post processor 168, and outputs the post processed data 158.

It will be appreciated that other computing architectures can be used to compute a time series of prediction vectors that are applicable to the principles described herein.

Below are further example aspects of the two-stage classifier-and-regressor model.

### Classifier

The selected binary classifier is an XGBoost tree model. Decision trees are prone to overfitting. Ensemble approaches are introduced to mitigate this problem. Ensemble methods combine several decision trees to produce better predictive performance than a single decision tree. Bagging and boosting are two main ensemble methods. Bagging averages the predictions from all individual trees. In boosting, trees are learned sequentially with each tree focusing on the misclassified samples (errors) of the previous trees. Gradient Boosting (GB) uses a gradient descent algorithm to minimize the error when adding new trees. Gradient Boosting methods are shown to surpass the bagging and regular boosting approaches in terms of performance and accuracy. Gradient Boosting focuses on the difficult samples which are typically the minority classes.

The XGBoost classifier 320 provides speed, efficiency, and scalability. XGBoost and Gradient Boosting are both ensemble tree methods that apply the principle of boosting weak learners using the gradient descent architecture. However, XGBoost improves upon the base Gradient Boosting framework through systems optimization and algorithmic enhancements. XGBoost introduces parallel processing, tree pruning, handling missing values, and certain regularizations to avoid overfitting.

Being an ensemble of decision trees, XGBoost benefits from high explainability and minimal assumptions about the variable scales or types which can contribute to minimizing the modelling risk.

In some cases, the XGBoost classifier offers intrinsic capability in treating outliers and different feature scales, which is an advantage offered by base learners used in XGBoost, decision-trees. In some cases, the XGBoost classifier also internally handles missing values. Treatment of missing values in Logistic models usually requires imputing them with other values or dropping the samples that contain missing values. These treatments can result in loss of valuable information (specially in heavily imbalanced datasets) as well as introducing unintended noise to the data.

### Regressor

The described regressor 304 is a deep neural network with an Encoder-Processor-Decoder scheme. Deep neural networks generally are more suitable for complex tasks such as temporal predictions. In some cases, the regressor 304 outperforms existing machine learning algorithms in terms of working with large amounts of high-dimensional data. Neural networks are more expressive; for example, they can better capture non-linear relationships in data. However, they come at a cost of more complicated implementation, and larger time and space (i.e., memory and processing) complexity.

A multilayer perceptron (MLP), also known as fully connected network, is considered in some cases to be a basic deep neural network architecture. It may be selected as both the Encoder and the Decoder. The Encoder 310 provides a lower dimensional feature vector (embedding) for the processor. It can lower the complexity of the processor by enabling it to work in a lower dimensional latent space. Likewise, the Decoder 316 can output the results with the desired dimension independent of the processor's dimension. This approach can decouple the processor complexity from the input and output vector size for more efficient processing.

The regressor 304, however, uses a different neural network architecture with higher inductive biases relevant to the temporal nature of the problem. It includes an attention mechanism 312 and the LSTM neural network model 314. The attention mechanism 312 helps the LSTM neural network model 314 to focus on important latent features in each timestep (also called a time period). Also, the LSTM neural network model 314 can predict the next timesteps' temporal outputs while remembering the previous timesteps' outputs.

### Attention Mechanism.

The attention mechanism 312 generally permits the Decoder 316 and processor to utilize the most relevant parts of the input sequence in a flexible manner, by a weighted combination of all the encoded input vectors, with the most relevant vectors being attributed the highest weights. In other words, it uses a weighted sum of all the encoder hidden states to flexibly focus the attention of the decoder/processor to the most relevant parts of the input sequence.

In some cases, the general attention mechanism makes use of three main components, namely the queries Q, keys K, and values V. It then performs the following computations.
1. Each query vector q (that is the previous decoder/processor output), is matched against a database of keys to compute a score value. This matching operation is computed as the dot product of the specific query under consideration with each key vector kᵢ:

e_{q,k}_{ᵢ}=q·kᵢ
2. The scores are passed through a Softmax operation to generate the weights:

α_{q,k}_{ᵢ}=Softmax(e_{q,k}_{ᵢ})
3. The generalized attention is then computed by a weighted sum of the value vectors vₖᵢ, where each value vector is paired with a corresponding key:

$$Attention ( q , K , V ) = {\sum }_{i} {α}_{q , {k}_{i}} {v}_{{k}_{i}}$$

The processor output (i.e., latent prediction vector) is the query, and the encoder output (i.e., latent feature vector) is the key and value. In this way, the initial latent feature vector is updated with respect to the previous output of the processor. In essence, in each time step, the model attends to specific elements of the latent feature vector. Therefore, it potentially helps to compute more accurate temporal predictions.

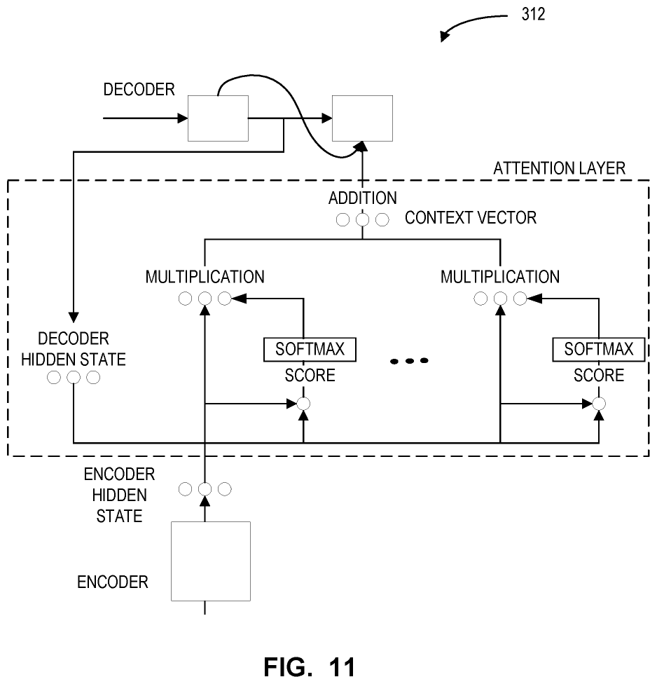

An example of the attention mechanism 312 is shown in FIG. 11.

### LSTM Neural Network Model

RNNs are a special type of neural network designed for sequence problems. RNNs have connections with loops, adding feedback and memory to the networks over time. This memory allows this type of network to learn and generalize across sequences of inputs/outputs rather than individual patterns. By way of background, the following are the taxonomy of sequence problems that involve mapping an input to output: (i) Vector-to-sequence: sequence output for image captioning; (ii) Sequence-to-vector: sequence input for sentiment classification; and (iii) Sequence-to-sequence: sequence in and out for machine translation.

The LSTM neural network model in some cases is particularly effective when stacked into a deep configuration, allowing application to a diverse array of problems from language translation to automatic captioning of images and videos. The LSTM network is trained using backpropagation through time and can overcome the vanishing gradient problem. As such, it can be used to create large (stacked) recurrent networks that, in turn, can be used to address difficult sequence problems in machine learning and achieve state-of-the-art results.

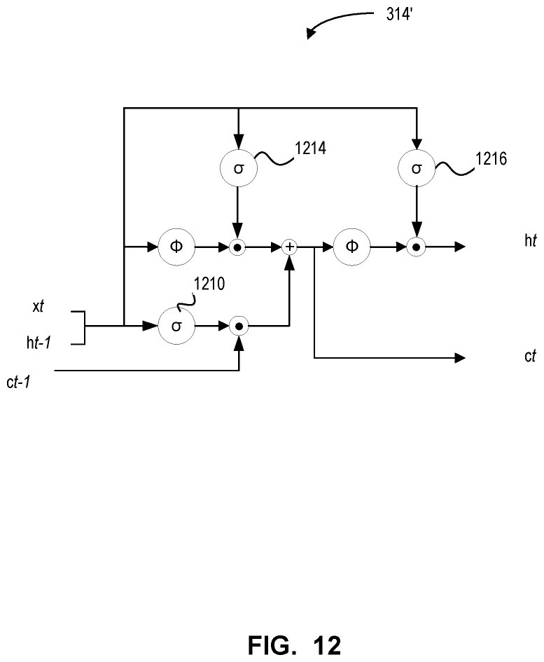

Instead of neurons, LSTM neural networks have memory blocks connected into layers. A block contains gates that manage the block's state and output. A unit operates upon an input sequence, and each gate within a unit uses the sigmoid activation function to control whether it is triggered or not, making the change of state and addition of information flowing through the unit conditional. In an example aspect, as shown in FIG. 12, a LSTM memory unit 314′ is controlled by several gates, according to an example embodiment. There is a forget gate 1210 that conditionally decides what information to discard from the memory unit. There is an input gate 1214 that conditionally decides which values from the input to update the memory state. There is an output gate 1216 that conditionally decides what to output based on input and the unit memory.

The LSTM memory unit 314′ takes input at the current time, xt, and from a previous time, ht−1, and it returns an output to be fed into the next time, ht. The final output of the LSTM memory unit is controlled by the input gate 1214, the forget gate 1210, and the output gate 1216, as well as the previous memory cell state, ct−1. The output also includes a current memory cell state ct.

### Training

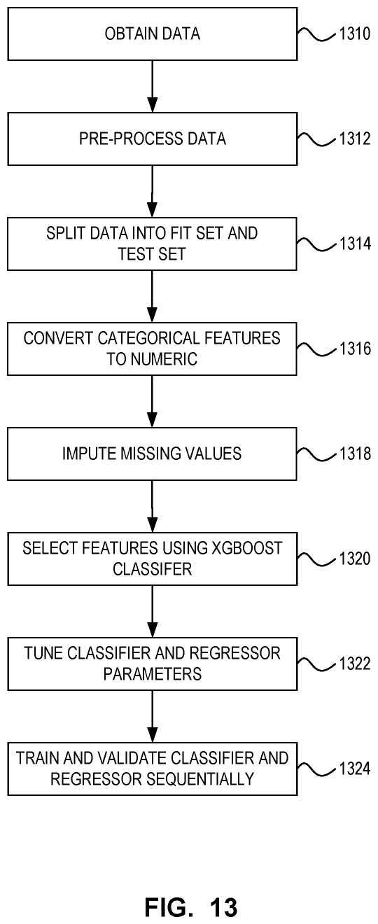

Referring now to FIG. 13, an example embodiment of a training process for the two-stage classifier-and-regressor model is provided. In some cases, the training process is executed by the trainer 162.
Block 1310: Obtain data.
Block 1312: Pre-process data.
Block 1314: Split the pre-processed data into a fit set and a test set. The fit set, for example, includes both training and validation datasets.
Block 1316: Convert categorical features to numeric values.
Block 1318: Impute missing values.
Block 1320: Select features using the XGBoost classifier.
Block 1322: Tune the classifier's and regressor's parameters.
Block 1324: Train and validate the classifier and the regressor sequentially.

In some cases, other types of training processes are used to train the two-stage classifier-and-regressor model.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g. 112a, or 1121). All elements with a common base number may be referred to collectively or generically using the base number without a suffix (e.g. 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. An apparatus for generating time series predictions from a first dataset comprising a first plurality of data entries and having a first feature space, comprising:
a memory storing instructions; and
one or more processors coupled to the memory, the one or more processors being configured to execute the instructions to:
encode the first dataset to generate a latent vector having a latent space smaller than the first feature space;
for a first time period (n=1) in a plurality of time periods:
process the latent vector using an attention mechanism to generate a first attention vector;
process the first attention vector using an LSTM (Long Short-Term Memory) neural network model to generate a first latent prediction vector;
decode the first latent prediction vector to generate a first prediction vector of a plurality of time series prediction vectors having a second feature space larger than the latent space;
for each successive n^{th} time period (n>1) in the plurality of time periods:
process the latent vector and an (n−1)^{th} latent prediction vector using the attention mechanism to generate an n^{th} attention vector;
process the n^{th} attention vector using the LSTM (Long Short-Term Memory) neural network model to generate an n^{th} latent prediction vector;
decode the n^{th} latent prediction vector to generate an n^{th} prediction vector of the plurality of time series prediction vectors in the second feature space;
classify the first dataset using an XGBoost (Extreme Gradient Boosting) classifier to generate a classified dataset, the classified dataset comprising a set of probability weights from 0 to 1;
scale each of the plurality of time series prediction vectors based on the classified dataset to generate a weighted plurality of time series prediction vectors, each of the weighted plurality of time series prediction vectors having a plurality of prediction values corresponding to the first plurality of data entries.

2. The apparatus of claim 1, wherein the instructions further cause the one or more processors to segment the weighted plurality of time series prediction vectors according to the plurality of prediction values.

3. The apparatus of claim 1, wherein the instructions further cause the one or more processors to provide for displaying a subset of the weighted plurality of time series prediction vectors.

4. The apparatus of claim 1, wherein the encoder, the attention mechanism, the LSTM neural network model, and the decoder form a regressor mechanism, and wherein the regressor mechanism is trained using a first training dataset and the XGBoost classifier is trained using a second training dataset, and wherein the first training dataset is a subset of the second training dataset.

5. The apparatus of claim 4, wherein the first training dataset is generated by trimming the second training dataset to remove entries associated with overrepresented values.

6. The apparatus of claim 5, wherein the overrepresented values are zeroes.

7. The apparatus of claim 1, wherein the one or more processors comprises a central processing unit (CPU) and a graphical processing unit (GPU).

8. The apparatus of claim 1, wherein the first plurality of data entries comprises a plurality of user accounts and data associated with each one of the plurality of user accounts.

9. The apparatus of claim 8, wherein each one of the weighted plurality of time series prediction vectors comprises a prediction value corresponding to a given user account of the plurality of user accounts, each one of the plurality of time periods is one month, and the one or more processors are configured to executed the instructions to further compile a specific set of prediction values from across the weighted plurality of time series prediction vectors that is specific to the given user account into at least a time graph or a time chart.

10. The apparatus of claim 9, wherein the data associated with each one of the plurality of user accounts comprises credit data, and the plurality of prediction values comprises a plurality of debt recovery rates corresponding to the plurality of time periods for the given user account.

11. A method for generating time series predictions from a first dataset comprising a first plurality of data entries and having a first feature space, the method executed in a computing environment comprising one or more processors and memory, the method comprising:
encoding the first dataset to generate a latent vector having a latent space smaller than the first feature space;
for a first time period (n=1) in a plurality of time periods:
processing the latent vector using an attention mechanism to generate a first attention vector;
processing the first attention vector using an LSTM (Long Short-Term Memory) neural network model to generate a first latent prediction vector;
decoding the first latent prediction vector to generate a first prediction vector of a plurality of time series prediction vectors having a second feature space larger than the latent space;
for each successive n^{th} time period (n>1) in the plurality of time periods:
processing the latent vector and an (n−1)^{th} latent prediction vector using the attention mechanism to generate an n^{th} attention vector;
processing the n^{th} attention vector using the LSTM (Long Short-Term Memory) neural network model to generate an n^{th} latent prediction vector;
decoding the n^{th} latent prediction vector to generate an n^{th} prediction vector of the plurality of time series prediction vectors in the second feature space;
classifying the first dataset using an XGBoost (Extreme Gradient Boosting) classifier to generate a classified dataset, the classified dataset comprising a set of probability weights from 0 to 1;
scaling each of the plurality of time series prediction vectors based on the classified dataset to generate a weighted plurality of time series prediction vectors, each of the weighted plurality of time series prediction vectors having a plurality of prediction values corresponding to the first plurality of data entries.

12. The method of claim 11 further comprising segmenting the weighted plurality of time series prediction vectors according to the plurality of prediction values.

13. The method of claim 11 further comprising providing for display a subset of the weighted plurality of time series prediction vectors.

14. The method of claim 11, wherein the encoder, the attention mechanism, the LSTM neural network model, and the decoder form a regressor mechanism, and wherein the regressor mechanism is trained using a first training dataset and the XGBoost classifier is trained using a second training dataset, and wherein the first training dataset is a subset of the second training dataset.

15. The method of claim 14, wherein the first training dataset is generated by trimming the second training dataset to remove entries associated with overrepresented values.

16. The method of claim 15, wherein the overrepresented values are zeroes.

17. The method of claim 11, wherein the one or more processors comprises a central processing unit (CPU) and a graphical processing unit (GPU).

18. The method of claim 11, wherein the first plurality of data entries comprises a plurality of user accounts and data associated with each one of the plurality of user accounts.

19. The method of claim 18, wherein each one of the weighted plurality of time series prediction vectors comprises a prediction value corresponding to a given user account of the plurality of user accounts, each one of the plurality of time periods is one month, and the method further comprises compiling a specific set of prediction values from across the weighted plurality of time series prediction vectors that is specific to the given user account into at least a time graph or a time chart.

20. A non-transitory computer readable medium storing computer executable instructions which, when executed by at least one computer processor, cause the at least one computer processor to carry out a method of generating time series predictions from a first dataset comprising a first plurality of data entries and having a first feature space, the method comprising:
encoding the first dataset to generate a latent vector having a latent space smaller than the first feature space;
for a first time period (n=1) in a plurality of time periods:
processing the latent vector using an attention mechanism to generate a first attention vector;
processing the first attention vector using an LSTM (Long Short-Term Memory) neural network model to generate a first latent prediction vector;
decoding the first latent prediction vector to generate a first prediction vector of a plurality of time series prediction vectors having a second feature space larger than the latent space;
for each successive n^{th} time period (n>1) in the plurality of time periods:
processing the latent vector and an (n−1)^{th} latent prediction vector using the attention mechanism to generate an n^{th} attention vector;
processing the n^{th} attention vector using the LSTM (Long Short-Term Memory) neural network model to generate an n^{th} latent prediction vector;
decoding the n^{th} latent prediction vector to generate an n^{th} prediction vector of the plurality of time series prediction vectors in the second feature space;
classifying the first dataset using an XGBoost (Extreme Gradient Boosting) classifier to generate a classified dataset, the classified dataset comprising a set of probability weights from 0 to 1;
scaling each of the plurality of time series prediction vectors based on the classified dataset to generate a weighted plurality of time series prediction vectors, each of the weighted plurality of time series prediction vectors having a plurality of prediction values corresponding to the first plurality of data entries.
